(19) United States
(12) Patent Application Publication
(10) Pub. No.: US 2019/0302804 A1
(43) Pub. Date: Oct. 3, 2019

(54) INERTIAL NAVIGATION SYSTEM USING ALL-ACCELEROMETER

(71) Applicant: King Fahd University of Petroleum and Minerals, Dhahran (SA)

(72) Inventors: Moustafa ELSHAFEI, Dhahran (SA); Yazan Mohammad Al-Rawashdeh, Dhahran (SA); Hassen Ouakad, Dhahran (SA)

(73) Assignee: King Fahd University of Petroleum and Minerals, Dhahran (SA)

(21) Appl. No.: 15/940,223

(22) Filed: Mar. 29, 2018

(51) Int. Cl. G05D 1/08; G01C 21/18; B64C 39/02; G01P 15/18

(52) U.S. Cl. CPC G05D 1/0816; G01C 21/18; B64C 39/024; B64C 2201/141; B64C 2201/027; B64C 2201/108; G01P 15/18

(57) ABSTRACT

A method for determining navigation parameters of a vehicle under varying center of gravity position, the method comprising, detecting a plurality of acceleration values via a plurality of accelerometers, calculating a plurality of differential values based on the acceleration values, calculating an initial inertia value of the vehicle based on the differential values, calculating an initial mass value of the vehicle based on the differential values, obtaining a plurality of disturbance parameters, calculating a refined inertia value based on the initial inertia value and a first one of the disturbance parameters, calculating a refined mass value based on the initial mass value and a second one of the disturbance parameters, and determining navigation parameters based on the refined inertia value and the refined mass value.

### BACKGROUND

Aerial robots have been widely used in various applications ranging from the simplest civilian to some advanced and sophisticated military applications. Cooperative robots, usually known as multi-agent robots, interact with each other or with other objects to accomplish certain mission objectives. One of the greatest challenges encountered in the design of aerial robotics is the direct interaction with their surrounding which requires them to be active agents. In general, fixing a manipulator on a quadrotor, attaching it to a slung load, or simply sharing the load with other agents directly affects the maneuverability of the quadrotor because of the unpredicted changes in its center of gravity (CoG) position, mass, and inertia. Thus, adaptive or robust control techniques are needed to ensure that the quadrotor dynamics are stabilized. Moreover, it is useful to identify these changes in real time to allow for better control actions and to enhance maneuverability as well robustness against any external disturbances.

Inertial sensors can play a significant role towards that direction; since they sense the inertial motion and in the same way they can be made suitable to measure the changes of particular kinematical quantities if they are used in plurality. Gyroscopes are one important example of this kind of sensor. However, their size is large when compared to accelerometers which are another example of inertial sensors. Additionally, gyroscopes tend to consume more power than accelerometers which makes the latter preferable to be used as an array to facilitate on-line estimation of the needed parameters. Even though linear accelerometers are usually used to measure the linear acceleration of the vehicle they are attached to, they can be utilized—as a group- to estimate both the angular velocity and orientation of the vehicle.

Equations for estimating center of gravity, mass, inertia, change in force, and change in torque are derived for an aerial vehicle during flight while interacting with unknown loads. These estimates are measured using a plurality of linear accelerometers' measurements in multiple configurations. Having the linear accelerometers arranged in particular configurations enables the direct measurement of several angular motion quantities that play a significant role in estimating the needed parameters. This in turn has significant impact on improving aerial vehicle stability.

An apparatus for tracking the center of gravity of an air vehicle was described in U.S. Pat. No. 8,260,477B2 entitled “METHOD AND APPARATUS FOR TRACKING CENTER OF GRAVITY OF AIR VEHICLE”, the entire disclosure of which is incorporated herein by reference. The apparatus estimates the angular velocity of the air vehicle from accelerometers measurements. The estimated vehicle angular velocity is then used to calculate both a center of gravity position and an inertial acceleration with respect to the vehicle's body frame using a suitable identification technique for a linear-in-parameters system. The estimation of the angular velocity may suffer from instability due to unstable nonlinear equations used. The accelerometers were arranged on rings. The rings are fitted into fore and aft positions of the air vehicles which impose some constraints on the airframe design.

Kinematical equations of an aircraft vehicle are derived under the assumption of varying center of gravity (CoG) position and under the influence of varying unknown gravitational force in U.S. Pat. No. 9,568,320 entitled “METHOD AND APPARATUS FOR ESTIMATION OF CENTER OF GRAVITY USING ACCELEROMETERS”, the entire disclosure of which is incorporated herein by reference. The apparatus uses high precision accelerometers arranged in a plurality of configurations. The vehicle receives measurements from accelerometers, calculates angular acceleration, filters the angular acceleration to obtain an angular velocity, and calculates navigation parameters using an identification technique. However, mass and inertia were not considered in the calculations.

A compensated controller system was designed to accommodate the changes in CoG position for a quadrotor where no estimation of the mass and inertia were presented in European patent 1,901,153, entitled “CONTROL SYSTEM FOR UNMANNED 4-ROTOR-HELIOPTER”, the entire disclosure of which is incorporated herein by reference.

A method for estimating multiple navigation parameters using a multiple concurrent recursive least squares identification (MCRLS ID) approach is presented in U.S. Pat. No. 7,110,915 entitled “MULTIPLE CONCURRENT RECURSEIVE LEAST SQUARES IDENTIFICATION WITH APPLICATION TO ON-LINE SPACECRAFT MASS-PROPERTY IDENTIFICATION”, the entire disclosure of which is incorporated herein by reference. The method relies on the use of gyroscopes, as opposed to accelerometers, and a single nonlinear problem is segmented into a plurality of separate linear problems that enables the application of linear regression algorithms such as recursive least squares instead of nonlinear optimization techniques. Moreover, the estimated quantities are still coupled in a way that prevents the estimation of inertia or its inverse without estimating the center of gravity position.

Hovering conditions were utilized to estimate the mass as well as the x and y coordinates of the center of gravity position of a quadrotor based on the force balance relations in D. W. Mellinger, “Trajectory generation and control for quadrotors” Publicly Accessible Penn Dissertations (2012), incorporated herein by reference in its entirety. However, the z-coordinate was not estimated and the inertia was assumed to have only the principle elements, according to Euler's equations, rather than the full inertia matrix. Moreover, the angular acceleration used was approximated using numerical differentiation.

A quadrotor's mass and inertia were assumed constant and Euler's equations were used to describe the dynamics of a quadrotor under center of gravity offset in I. Palunko and R. Fierro, “Adaptive control of a quadrotor with dynamic changes in the center of gravity” Proceedings 18th IFAC World Congress (2011), incorporated herein by reference in its entirety.

A quadrotor's mass and inertia were estimated using an adaptive technique under the assumption of fixed center of gravity position in R. Lopez, et al. “Real-time parameters identification for a quad-rotor mini-aircraft using adaptive control” Unmanned Aircraft Systems (ICUAS), 2014 International Conference on IEEE (2014), incorporated herein by reference in its entirety.

Therefore, there is a need for a method and system for estimating the mass and inertia of an aerial vehicle equipped with accelerometers while interacting with unknown loads via an optional manipulator arm and under the influence of varying disturbances.

The foregoing “background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention. The foregoing paragraphs have been provided by way of general introduction, and are not intended to limit the scope of the following claims. The described embodiments, together with further advantages, will be best understood by reference to the following detailed description taken in conjunction with the accompanying drawings.

### SUMMARY

The present disclosure relates to method and system for real-time estimation of center of gravity, mass, inertia, change in force, and change in torque using several accelerometers.

In one embodiment of the invention, a method for determining navigation parameters of a vehicle under varying center of gravity position is presented, the method comprising: detecting a plurality of acceleration values via a plurality of accelerometers, calculating a plurality of differential values based on the acceleration values, calculating an initial inertia value of the vehicle based on the differential values, calculating an initial mass value of the vehicle based on the differential values, estimating force and torque disturbances, calculating a refined inertia value based on the initial inertia and the estimated torque disturbance values, calculating a refined mass value based on the initial mass value and the estimated force disturbance values, and determining navigation parameters based on the refined inertia value and the refined mass value, and controlling the vehicle based on the navigation parameters.

In another embodiment, a system for determining navigation parameters of a vehicle is presented, the system comprises processing circuitry configured: to detect a plurality of angular acceleration values via a plurality of accelerometers mounted on the vehicle wherein said vehicle is in motion, calculate a plurality of differential values based on the acceleration values, calculate an initial inertia value of the vehicle based on the differential values, calculate an initial mass value of the vehicle based on the differential values, obtain a plurality of disturbance parameters, calculate a refined inertia value based on the initial inertia value and a first one of the disturbance parameters, calculate a refined mass value based on the initial mass value and a second one of the disturbance parameters, determine navigation parameters based on the refined inertia value and the refined mass value, and control the vehicle based on the navigation parameters.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is a schematic diagram of a quadrotor with the all-accelerometer installation in a diamond configuration according to one or more aspects of the disclosed subject matter;

FIG. 1B is a schematic diagram of a quadrotor with the all-accelerometer installation in a cone configuration according to one or more aspects of the disclosed subject matter;

FIG. 2 is a schematic that shows the inertial and body frames of reference according one or more aspects of the disclosed subject matter;

FIG. 3 is a block diagram that shows the recursive estimation loop of CoG position, total mass and total inertia according to one or more aspects of the disclosed subject matter;

FIG. 4 is a flow chart showing a method for solving the navigation parameters according to one or more aspects of tit disclosed subject matter; and

FIG. 5 is an exemplary block diagram of a computer according to one or more aspects of the disclosed subject matter.

### DETAILED DESCRIPTION

Referring now to the drawings, wherein like reference numerals designate identical or corresponding parts throughout several views, the following description relates to a system, apparatus, and associated methodology for enhanced navigation.

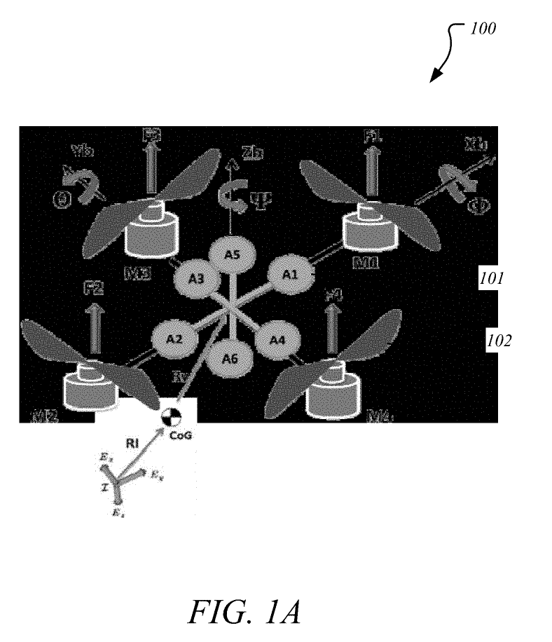

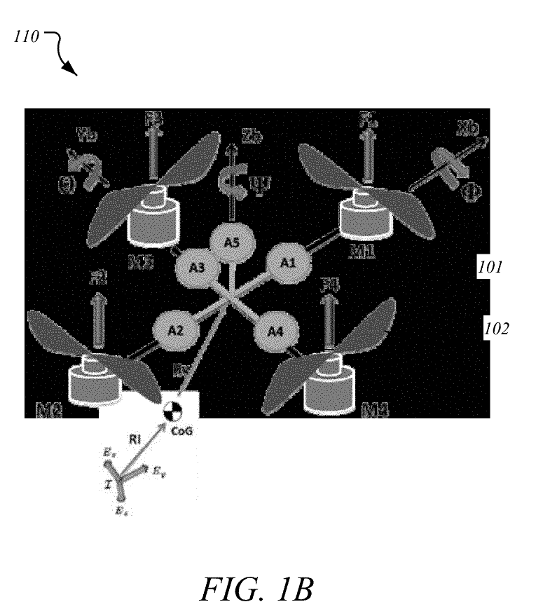

The system of the present disclosure may be used in various military applications and other exploration missions. The system can include a vehicle, for example a quadrotor with an air frame, a drone, a helicopter, or a hovercraft, configured to aerially navigate an environment via a plurality of propellers 102. In other embodiments, the vehicle can include turbines instead of propellers 102. The propellers 102 can apply force to the vehicle to cause motion, wherein the vehicle can move in a vertically upwards direction away from a ground surface as well as horizontally left, right, forwards, backwards, or a combination thereof. A combination of forces can also be applied to cause the vehicle to take an angled turn, wherein the vehicle adjusts its roll, or rotation about an axis running front to back, pitch, or rotation about an axis running from left to right (wing to wing), and yaw, or rotation about an axis running vertically up and down. Motion can include the propellers 102 reducing the applied force on the vehicle to allow descent towards the ground surface. Moreover, motion can include the propellers 102 applying force to the vehicle wherein the vehicle remains at a constant height above the ground surface, e.g. hovering. Other motions include displacement in 2 dimensions and 3 dimensions. The system and apparatus as shown in FIGS. 1A and 1B may include a plurality of accelerometers 101 installed at predetermined locations configured to measure flight parameters. The accelerometer type can be, for example, mechanical, capacitive, or piezoelectric. The accelerometer can be a linear accelerometer, wherein the linear accelerometer measures the acceleration applied, excluding the force of gravity. The system and apparatus may adopt a standard configuration wherein no payloads are attached to the apparatus, as well as a configuration that includes a manipulator arm configured to secure and carry at least one payload from a first destination to a final destination, optionally via one or more destinations between the first and final destination.

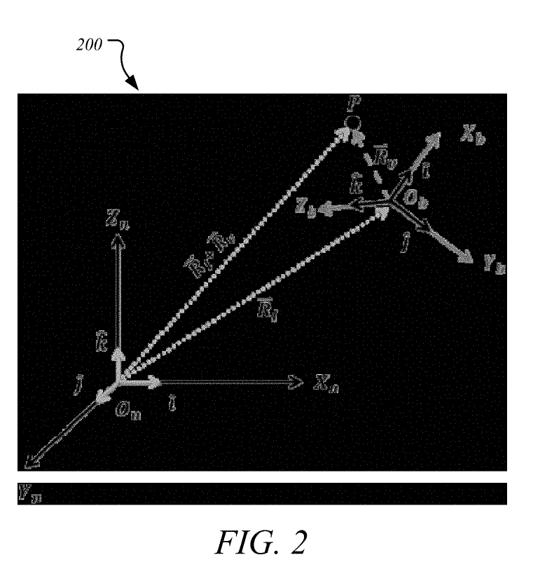

The preferred positions to install the linear accelerometers 101 are at the quadrants of a sphere with radius μ centered at the geometric center of the vehicle body frame. In an exemplary embodiment, the vehicle can be a quadrotor and include six tri-axial linear accelerometers 101, which can ensure determining the value of the angular acceleration directly and algebraically using the available accelerometers' 101 measurements. The linear accelerometers can be arranged in a tetrahedral configuration, for example a “diamond” configuration, wherein pairs of the linear accelerometers are positioned along the three major axes and equidistant from the geometric center of the quadrotor body frame. For example, each of four accelerometers can be installed along a propeller arm of the quadrotor as well as one centered above and one centered below the geometric center of the quadrotor. In another embodiment, the preferred number of tri-axial linear accelerometers 101 to be used is five, also known as a “cone” configuration, wherein a manipulator arm can take the place of one of the accelerometers 101, for example the accelerometer disposed below the geometric center of the quadrotor and closest to the ground surface, and be configured to carry a payload. FIGS. 1A and 1B illustrate the exemplary quadrotor 100 with six tri-axial linear accelerometers 101 and the alternative quadrotor 110 with five tri-axial linear accelerometers 101, respectively, denoted by Aᵢ, attached to an airframe. FIG. 2 illustrates a detailed explanation of the frames of reference.

Adopting a flat non-rotating Earth model, the measurements of an accelerometer 101 located at point P may be expressed as:

[symbol]

= [symbol] _{I}+ [symbol] × [symbol] + [symbol] ᵥ+2 [symbol] × [symbol] + [symbol] ×( [symbol] × [symbol] ᵥ)− [symbol] (1)

where [symbol] is the inertial acceleration of an arbitrary point P measured in body coordinate frame (O_{b}X_{b}Y_{b}Z_{b}) where the accelerometer 101 is assumed to be aligned with the body frame, [symbol] is the linear acceleration of the origin of the body coordinate frame, i.e., CoG, with respect to inertial space (OₙXₙYₙZₙ) as measured in the body frame, [symbol] is the vector from the origin of the body coordinate frame (O_{b}) to point P written in the body frame, [symbol] is its time derivative, [symbol] is the angular velocity of the body frame, [symbol] is the angular acceleration of the body frame, x denotes the cross product between two vectors, and [symbol] is the gravitational acceleration written in the body frame.

Considering the CoG to be stationary, i.e., [symbol] = [symbol] = [symbol] , then the accelerometer 101 measurements at a point P may be expressed as:

[symbol]

= [symbol] + [symbol] × [symbol] + [symbol] ×( [symbol] × [symbol] )− [symbol] (2)

Using equation (1), the accelerometers' 101 measurements in the quadrotor body frame as illustrated in FIG. 1 may be expressed as:

$${\vec{A}}_{1} = \vec{U} + \dot{\vec{Ω}} \times ( {\vec{R}}_{v} + μ \vec{i} ) + \vec{Ω} \times ( \vec{Ω} \times ( {\vec{R}}_{v} + μ \vec{i} ) ) \\ {\vec{A}}_{2} = \vec{U} + \dot{\vec{Ω}} \times ( {\vec{R}}_{v} - μ \vec{i} ) + \vec{Ω} \times ( \vec{Ω} \times ( {\vec{R}}_{v} - μ \vec{i} ) ) \\ {\vec{A}}_{3} = \vec{U} + \dot{\vec{Ω}} \times ( {\vec{R}}_{v} + μ \vec{j} ) + \vec{Ω} \times ( \vec{Ω} \times ( {\vec{R}}_{v} + μ \vec{j} ) ) \\ {\vec{A}}_{4} = \vec{U} + \dot{\vec{Ω}} \times ( {\vec{R}}_{v} - μ \vec{j} ) + \vec{Ω} \times ( \vec{Ω} \times ( {\vec{R}}_{v} - μ \vec{j} ) ) \\ {\vec{A}}_{5} = \vec{U} + \dot{\vec{Ω}} \times ( {\vec{R}}_{v} + μ \vec{k} ) + \vec{Ω} \times ( \vec{Ω} \times ( {\vec{R}}_{v} + μ \vec{k} ) ) \\ {\vec{A}}_{6} = \vec{U} + \dot{\vec{Ω}} \times ( {\vec{R}}_{v} - μ \vec{k} ) + \vec{Ω} \times ( \vec{Ω} \times ( {\vec{R}}_{v} - μ \vec{k} ) ) \\ where \vec{U} = {\ddot{\vec{R}}}_{I} + {\ddot{\vec{R}}}_{v} + 2 \vec{Ω} \times {\dot{\vec{R}}}_{v} - {\vec{g}}_{b} . {\ddot{\vec{R}}}_{I} = {[ {a}_{x} , {a}_{y} , {a}_{z} ]}^{T} , {\vec{R}}_{v} = {[ {r}_{vx} , {r}_{vy} , {r}_{vz} ]}^{T} , \vec{Ω} = {[ {Ω}_{x} , {Ω}_{y} , {Ω}_{z} ]}^{T} \qquad ( 3 )$$

and [symbol] denotes the transpose. Unlike (2), in (3) [symbol] and [symbol] are assumed non-zero in general.

By using the skew-symmetric matrix notation instead of the cross product, the accelerometer 101 measurements of A₁ may be expressed as:

$$[ \begin{matrix}{A}_{1 x} \\ {A}_{1 y} \\ {A}_{1 z}\end{matrix} ] = {\ddot{\vec{R}}}_{I} + {\ddot{\vec{R}}}_{v} + 2 M {\dot{\vec{R}}}_{v} + \dot{M} [ \begin{matrix}{r}_{vx} + μ \\ {r}_{vy} \\ {r}_{vz}\end{matrix} ] + N [ \begin{matrix}{r}_{vx} + μ \\ {r}_{vy} \\ {r}_{vz}\end{matrix} ] - {\vec{g}}_{b} \\ where \\ M = [ \begin{matrix}0 & - {Ω}_{z} & {Ω}_{y} \\ {Ω}_{z} & 0 & - {Ω}_{x} \\ - {Ω}_{y} & {Ω}_{x} & 0\end{matrix} ] , N = [ \begin{matrix}- {Ω}_{z}^{2} - {ω}_{y}^{2} & {Ω}_{x} {Ω}_{y} & {Ω}_{x} {Ω}_{z} \\ {Ω}_{x} {Ω}_{y} & - {Ω}_{z}^{2} - {Ω}_{x}^{2} & {Ω}_{z} {Ω}_{y} \\ {Ω}_{x} {Ω}_{z} & {Ω}_{z} {Ω}_{y} & - {Ω}_{y}^{2} - {Ω}_{x}^{2}\end{matrix} ] \qquad ( 4 )$$

B. Estimating the Angular Motion Using all-Accelerometer

For the configuration in FIG. 1A, by taking the differential output of each pair of accelerometers 101 along a primary axis, the following stacked system of equations can be obtained as given in Al-Rawashdeh, Yazan Mohammad, Moustafa Elshafei, and Mohammad Fahad Al-Malki. “In-Flight Estimation of Center of Gravity Position Using All-Accelerometers.” Sensors (2014) incorporated herein by reference in its entirety:

$$[ \frac{{\vec{A}}_{1} - {\vec{A}}_{2}}{2 μ} , \frac{{\vec{A}}_{3} - {\vec{A}}_{4}}{2 μ} , \frac{{\vec{A}}_{5} - {\vec{A}}_{6}}{2 μ} ] = \dot{M} + N = B \qquad ( 5 )$$

The same steps can be taken to obtain a set of equations describing the configuration of FIG. 1B, which may be expressed as:

$$[ \frac{{\vec{A}}_{1} - {\vec{A}}_{3}}{2 μ} \frac{{\vec{A}}_{2} - {\vec{A}}_{4}}{2 μ} \frac{{\vec{A}}_{5} - {\sum }_{i = 1}^{4} {\vec{A}}_{i}}{L} ] = [ \begin{matrix}0 & - {\dot{Ω}}_{z} & {\dot{Ω}}_{y} \\ {\dot{Ω}}_{z} & 0 & - {\dot{Ω}}_{x} \\ - {\dot{Ω}}_{y} & {\dot{Ω}}_{x} & 0\end{matrix} ] + [ \begin{matrix}- {Ω}_{z}^{2} - {Ω}_{y}^{2} & {Ω}_{x} {Ω}_{y} & Ω \\ {Ω}_{x} {Ω}_{y} & - {Ω}_{z}^{2} - {Ω}_{x}^{2} & Ω \\ {Ω}_{x} {Ω}_{z} & {Ω}_{z} {Ω}_{y} & - Ω\end{matrix} \qquad ( 5 A )$$

where L denotes the distance by which A₅ is away from the geometric center of the IMU which coincides with the quadrotor's geometric center.

Solving the previous system, the angular motion quantities needed to estimate the CoG position and inertia may be expressed as:

$$\begin{matrix}{\dot{Ω}}_{x} = \frac{1}{4 μ} ( {A}_{3 z} - {A}_{4 z} - {A}_{5 y} + {A}_{6 y} ) & ( 6 ) \\ {\dot{Ω}}_{y} = \frac{1}{4 μ} ( {A}_{5 x} - {A}_{6 x} - {A}_{1 z} + {A}_{2 z} ) & ( 7 ) \\ {\dot{Ω}}_{z} = \frac{1}{4 μ} ( {A}_{1 y} - {A}_{2 y} - {A}_{3 x} + {A}_{4 x} ) & ( 8 ) \\ {Ω}_{x} {Ω}_{y} = \frac{1}{4 μ} ( {A}_{1 y} - {A}_{2 y} + {A}_{3 x} - {A}_{4 x} ) & ( 9 ) \\ {Ω}_{x} {Ω}_{z} = \frac{1}{4 μ} ( {A}_{1 z} - {A}_{2 z} + {A}_{5 x} - {A}_{6 x} ) & ( 10 ) \\ {Ω}_{y} {Ω}_{z} = \frac{1}{4 μ} ( {A}_{3 z} - {A}_{4 z} + {A}_{5 y} - {A}_{6 y} ) & ( 11 ) \\ {Ω}_{x}^{2} = \frac{1}{4 μ} ( {A}_{1 x} - {A}_{2 x} - {A}_{3 y} + {A}_{4 y} - {A}_{5 z} + {A}_{6 z} ) & ( 12 ) \\ {Ω}_{y}^{2} = \frac{1}{4 μ} ( - {A}_{1 x} + {A}_{2 x} + {A}_{3 y} - {A}_{4 y} - {A}_{5 z} + {A}_{6 z} ) & ( 13 ) \\ {Ω}_{z}^{2} = \frac{1}{4 μ} ( - {A}_{1 x} + {A}_{2 x} - {A}_{3 y} + {A}_{4 y} + {A}_{5 z} - {A}_{6 z} ) & ( 14 )\end{matrix}$$

C. Estimating the Inertial Acceleration and CoG Position

By using all-accelerometer technique, estimates of the inertial acceleration as measured in the quadrotor body frame, i.e. [symbol] , and the CoG position, i.e. [symbol] , measured with respect to the quadrotor geometric center can be obtained. By adding the accelerometers' 101 measurements while assuming a stationary CoG along with known gravitational acceleration, the following can be obtained:

$$\frac{1}{6} {\sum }_{i = 1}^{6} {\vec{A}}_{i} + {\vec{g}}_{b} = {\ddot{\vec{R}}}_{I} + [ \frac{{\vec{A}}_{1} - {\vec{A}}_{3}}{2 μ} \frac{{\vec{A}}_{2} - {\vec{A}}_{4}}{2 μ} \frac{{\vec{A}}_{5} - {\vec{A}}_{6}}{2 μ} ] {\vec{R}}_{v} = {\ddot{\vec{R}}}_{I} + B {\vec{R}}_{v} \qquad ( 15 )$$

[symbol] can also be estimated when treated as a constant or slowly varying. In one embodiment, it is also assumed that the quadrotor is equipped with its own navigation system that can provide the orientation of the quadrotor with respect to the used navigation frame. This last assumption ensures that [symbol] is accessible at any time.

Using a suitable identification technique, it is possible to estimate the CoG position and the quadrotor inertial acceleration simultaneously.

The total forces [symbol] and total torques ( [symbol] ) acting on a quadrotor can be classified into two parts. For example, known quantities that can be calculated, and unknown quantities that need to be identified. These quantities can be modelled using Newton's second law and may be expressed as:

$$\begin{matrix} {\vec{F}}_{Total} = {\sum }_{i = 1}^{q} {\vec{F}}_{i} + {\vec{F}}_{dist} = {\vec{F}}_{propellers} + {\vec{F}}_{dist} = {m}_{Total} ( {\ddot{\vec{R}}}_{I} + {\vec{g}}_{b} ) & ( 16 ) \\ {\vec{T}}_{Total} = {\sum }_{i = 1}^{q} ( {\vec{d}}_{i} \times {\vec{F}}_{i} ) + {\vec{T}}_{dist} = {\vec{T}}_{propellers} + {\vec{T}}_{dist} = {I}_{Total} \dot{\vec{Ω}} + \vec{Ω} \times {I}_{Total} \vec{Ω} & ( 17 )\end{matrix}$$

where q is the number of propellers 102 used, [symbol] is the force generated by the i^{th} motor-propeller setup, [symbol] is the position of the i^{th} propeller hub with respect to the CoG, m_{Total} is the total mass of the quadrotor and the added objects, I_{Total} is the total inertia of the quadrotor and the added objects evaluated at CoG, [symbol] _{dist} stands for all unknown forces resulting from drag forces, propeller 102 flapping and the like, and [symbol] stands for all unknown torques resulting from drag forces, propeller 102 flapping and the like.

As a matter of fact, many of the aerodynamics forces and torques can be calculated based on a known CoG position and other parameters as well. For example, this allows the quadrotor linear velocity, i.e. [symbol] to be calculated, and then the linear velocity ( [symbol] ) that the motor-propeller setup experiences can be estimated with respect to the quadrotor body frame, which may be expressed as:

[symbol]

= [symbol] + [symbol] × [symbol] (18)

where [symbol] is obtained using an appropriate filtration technique.

Knowing [symbol] the forces and torques resulting from the i^{th} propeller 102 flapping can be calculated as given in Xiaodong Zhang, Xiaoli Li, Kang Wang, and Yanjun Lu, “A Survey of Modelling and Identification of Quadrotor Robot”, Abstract and Applied Analysis (2014) incorporated herein by reference in its entirety. In such case, these forces and torques can be added to the left sides of equations (16) and (17) and the problem can be undertaken.

Since the CoG can migrate because of dynamic loading of the quadrotor or the movement of the attached manipulators, the total inertia matrix, i.e. I_{Total} is no longer constant and can be considered as unknown. Equation (17) can be used to estimate the resulting inertia matrix which may be expressed as given in Jerry H. Ginsberg, “Advanced Engineering Dynamics”, Cambridge University Press (1998) incorporated herein by reference in its entirety:

$${I}_{Total} = [ \begin{matrix}{I}_{xx} & - {I}_{xy} & - {I}_{xz} \\ - {I}_{xy} & {I}_{yy} & - {I}_{yz} \\ - {I}_{xz} & - {I}_{yz} & {I}_{zz}\end{matrix} ] \qquad ( 19 )$$

Being symmetric, the inertia matrix has only six unknowns to be identified. The identification problem may be expressed as follows when \vec{T}_{dist} is negligible and I_{Total} is slowly varying:

$${T}_{Total} = {\vec{T}}_{propellers} = [ \begin{matrix}{\dot{Ω}}_{x} & - {Ω}_{y} {Ω}_{z} & {Ω}_{y} {Ω}_{z} \\ {Ω}_{x} {Ω}_{z} & {\dot{Ω}}_{y} & - {Ω}_{x} {Ω}_{z} \\ - {Ω}_{x} {Ω}_{y} & {Ω}_{x} {Ω}_{y} & {\dot{Ω}}_{z}\end{matrix} \qquad ( 20 )$$

where the angular motion quantities can be used directly from equations (6)-(14).

D. Estimating the Mass and Inertia

Using the Parallel Axis Theorem (PAT) the inertia moments and products of the i^{th} motor-propeller setup with respect to the CoG may be expressed as:

$${I}_{mi , x}^{′} = {I}_{mi , x}^{0} + {m}_{mi} ( {[ {l}_{mi , y} - {r}_{vy} ]}^{2} + {[ {l}_{mi , z} - {r}_{vz} ]}^{2} ) \\ {I}_{mi , y}^{′} = {I}_{mi , y}^{0} + {m}_{mi} ( {[ {l}_{mi , x} - {r}_{vx} ]}^{2} + {[ {l}_{mi , z} - {r}_{vz} ]}^{2} ) \\ {I}_{mi , z}^{′} = {I}_{mi , z}^{0} + {m}_{mi} ( {[ {l}_{mi , x} - {r}_{vx} ]}^{2} + {[ {l}_{mi , y} - {r}_{vy} ]}^{2} ) \\ {I}_{mi , xy}^{′} = {I}_{mi , xy}^{0} + {m}_{mi} ( {l}_{mi , x} - {r}_{vx} ) ( {l}_{mi , y} - {r}_{vy} ) \\ {I}_{mi , xz}^{′} = {I}_{mi , xz}^{0} + {m}_{mi} ( {l}_{mi , x} - {r}_{vx} ) ( {l}_{mi , z} - {r}_{vz} ) \\ {I}_{mi , yz}^{′} = {I}_{mi , yz}^{0} + {m}_{mi} ( {l}_{mi , y} - {r}_{vy} ) ( {l}_{mi , z} - {r}_{vz} ) \qquad ( 21 )$$

where {i=1, 2, . . . , q} indicates the motor-propeller setup index, and the values of both Iₘᵢ⁰ and mₘᵢ, i.e. the inertia and mass of the i^{th} motor-propeller setup respectively, are usually considered known.

The ideal values of the motors positions, when measured at their centers of masses with respect to the geometric center of the quadrotor and arranged in a plus configuration, may be expressed as:

$${l}_{m 1} = {[ l , 0 , 0 ]}^{T} , {l}_{m 3} = {[ 0 , l , 0 ]}^{T} \\ {l}_{m 2} = {[ - l , 0 , 0 ]}^{T} , {l}_{m 4} = {[ 0 , - l , 0 ]}^{T} \qquad ( 22 )$$

where the motors are located in the quadrants of a circle with radius l meters.

If the quadrotor airframe is approximated as two identical, thin and right-angle crossed cylinders, then their inertia moments and products with respect to the CoG may be expressed as follows:

$${I}_{ck , x}^{′} = {I}_{ck , x}^{0} + {m}_{c} ( {r}_{vy}^{2} + {r}_{vz}^{2} ) \\ {I}_{ck , y}^{′} = {I}_{ck , y}^{0} + {m}_{c} ( {r}_{vx}^{2} + {r}_{vz}^{2} ) \\ {I}_{ck , z}^{′} = {I}_{ck , z}^{0} + {m}_{c} ( {r}_{vx}^{2} + {r}_{vy}^{2} ) \\ {I}_{ck , xy}^{′} = {I}_{ck , xy}^{0} + {m}_{c} {r}_{vx} {r}_{vy} \\ {I}_{ck , xz}^{′} = {I}_{ck , xz}^{0} + {m}_{c} {r}_{vx} {r}_{vz} \\ {I}_{ck , yz}^{′} = {I}_{ck , yz}^{0} + {m}_{c} {r}_{vy} {r}_{vz} \qquad ( 23 )$$

where k={1,2} is the cylinder index. Notice that I_{c2}⁰ is rotated ninety degrees about the quadrotor z-axis when compared to I_{c1}⁰.

Practically speaking, the values of I_{ck}⁰ and m_{c} can be estimated off-line as given in Jorge Migue Brito Domingues, “Quadrotor Prototype”, Uneversidade Tecnica de Lisboa, Dissertacio (2009) incorporated herein by reference in its entirety. However, the payload mass (mₚ) and inertia (Iₚ) values are still to be identified. The overall inertia at the CoG position may be expressed as:

$${I}_{{Total}_{x , y , z}} = {\sum }_{i = 1}^{q} {I}_{mi , x , y , z}^{′} + {\sum }_{k = 1}^{2} {I}_{ck , x , y , z}^{′} + {I}_{p , x , y , z} \\ {I}_{{Total}_{xy , xz , yz}} = {\sum }_{i = 1}^{q} {I}_{mi , xy , xz , yz}^{′} + {\sum }_{k = 1}^{2} {I}_{ck , xy , xz , yz}^{′} + {I}_{p , xy , xz , yz} \qquad ( 24 )$$

Equation (20) has common terms with opposite signs in the coefficient matrix of the principle inertia elements which may deteriorate the identification of I_{Total} elements if identified concurrently. Thus, equation (20) can be re-written as follows:

$${\vec{T}}_{Total} = {\vec{T}}_{propellers} = [ \begin{matrix}{\dot{Ω}}_{x} + {Ω}_{y} {Ω}_{z} & {\dot{Ω}}_{x} - {Ω}_{y} {Ω}_{z} & 0 \\ 0 & {\dot{Ω}}_{y} + {Ω}_{x} {Ω}_{z} & - {\dot{Ω}}_{y} + {Ω}_{x} {Ω}_{z} \\ {\dot{Ω}}_{z} - {Ω}_{x} {Ω}_{y} & 0 & - {\dot{Ω}}_{z} - {Ω}_{x} {Ω}_{y}\end{matrix} ] [ \begin{matrix}{s}_{1} \\ {s}_{2} \\ {s}_{3}\end{matrix} ] + [ \begin{matrix}{\dot{Ω}}_{y} - {Ω}_{x} {Ω}_{z} & {\dot{Ω}}_{z} + {Ω}_{x} {Ω}_{y} & {Ω}_{y}^{2} - {Ω}_{z}^{2} \\ {\dot{Ω}}_{x} + {Ω}_{y} {Ω}_{z} & {Ω}_{z}^{2} - {Ω}_{x}^{2} & {\dot{Ω}}_{z} - {Ω}_{x} {Ω}_{y} \\ {Ω}_{x}^{2} - {Ω}_{y}^{2} & {\dot{Ω}}_{x} - {Ω}_{y} {Ω}_{z} & {\dot{Ω}}_{y} + {Ω}_{x} {Ω}_{z}\end{matrix} ] [ \begin{matrix}{I}_{xy} \\ {I}_{xz} \\ {I}_{yz}\end{matrix} ] \\ where \text{:} \\ [ \begin{matrix}{s}_{1} \\ {s}_{2} \\ {s}_{3}\end{matrix} ] = [ \begin{matrix}1 & - 1 & 1 \\ 1 & 1 & - 1 \\ 1 & - 1 & - 1\end{matrix} ] [ \begin{matrix}{I}_{xx} \\ {I}_{yy} \\ {I}_{zz}\end{matrix} ] \qquad ( {20}^{′} )$$

After estimating I_{Total} using equation (20) or equation (20′), and estimating the CoG position using equation (15), Iₘᵢ′ and I_{ck}′ can be calculated, and then the payload inertia can be calculated using equation (24). If the quadrotor is equipped with manipulators with DOF greater than 1, then the moments of inertia variations due to the manipulator joint angles, i.e., pose, can be calculated at the CoG and added to (24).

Similarly, the payload mass, i.e., mₚ, when disturbances are negligible, can be estimated and expressed as:

$${m}_{Total} = \frac{{‖ {\vec{F}}_{propellers} ‖}_{2}}{{‖ {\ddot{\vec{R}}}_{I} + {\vec{g}}_{b} ‖}_{2}} , {‖ {\ddot{\vec{R}}}_{I} + {\vec{g}}_{b} ‖}_{2} \neq 0 \\ {m}_{p} = {m}_{Total} - {\sum }_{i = 1}^{q} {m}_{mi} - 2 {m}_{c} \qquad ( 27 )$$

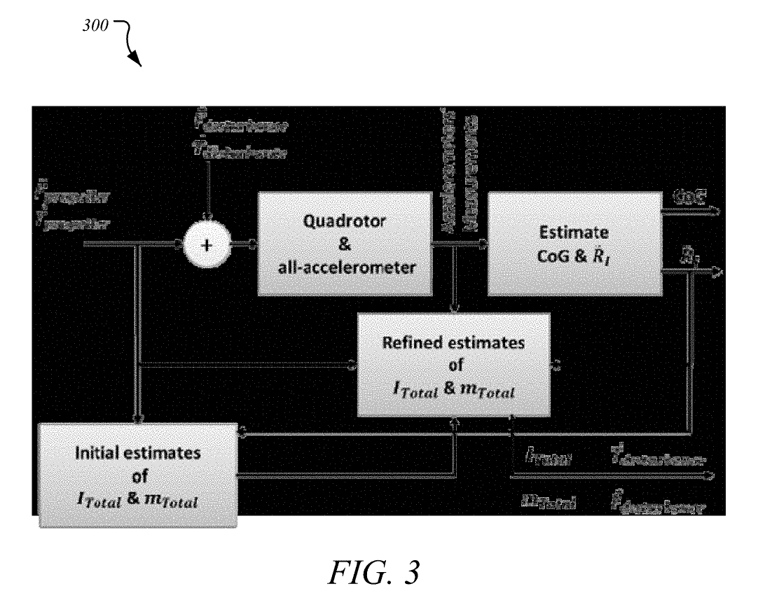

Neglecting the disturbances, if any, may result in inaccurate estimates for both the total mass and inertia; hence FIG. 3 illustrates that these estimates can be refined by including these disturbances into the identification model to obtain more accurate parameters estimations. In light of this, the results obtained by equations (20), (20′) and (27) can be considered as initial estimations for the identification problems described as follows:

$$\begin{matrix}\dot{\vec{Ω}} = {I}_{Total}^{- 1} {\vec{T}}_{propellers} + {I}_{Total}^{- 1} {\vec{T}}_{dist} - {I}_{Total}^{- 1} ( \vec{Ω} \times {I}_{Total} \vec{Ω} ) & ( 28 ) \\ {\vec{F}}_{propellers} = [ \begin{matrix}{\ddot{R}}_{I , x} + {g}_{b , x} & - 1 & 0 & 0 \\ {\ddot{R}}_{I , y} + {g}_{b , y} & 0 & - 1 & 0 \\ {\ddot{R}}_{I , z} + {g}_{b , z} & 0 & 0 & - 1\end{matrix} ] [ \begin{matrix}{m}_{Total} \\ {F}_{dist , x} \\ {F}_{dist , y} \\ {F}_{dist , z}\end{matrix} ] & ( 29 )\end{matrix}$$

where I_{Total} is assumed to be invertible.

The new total inertia identification problem is nonlinear and can be solved using a nonlinear least squares estimation method which can be implemented using the “lsqnonlin” MATLAB function. Since the identification problem is under-determined, the Levenberg-Marquardt algorithm, as given in Jorge J. More “Levenberg-Marquardt Algorithm: Implementation and Theory”, Numerical Analysis, ed. G. A. Watson, Lecture Notes in Mathematics, Springer Verlag (1977) incorporated herein by reference in its entirety, can be used to facilitate the functionality of lsqnonlin function. It should be noted that the solution of the optimization problem might only be local and that is why equation (20) or equations (20′) and (27) are first used to decide the neighborhood of the solution search-space. The optimization problem may be expressed as:

$${min}_{r} {‖ \vec{e} ( r ) ‖}_{2}^{2} \\ \vec{e} ( r ) = \dot{\vec{Ω}} - {I}_{Total}^{- 1} {\vec{T}}_{propellers} - {I}_{Total}^{- 1} {\vec{T}}_{dist} + {I}_{Total}^{- 1} ( \vec{Ω} \times I \qquad ( 30 )$$

where: r represents the decision variables to be determined, namely {Iₓₓ,I_{yy},I_{zz},I_{xy},I_{xz},I_{yz},Tdₓ,Td_{y},Td_{z}}, such that \vec{T}_{dist}=[Tdₓ,Td_{y},Td_{z}]^{T}.

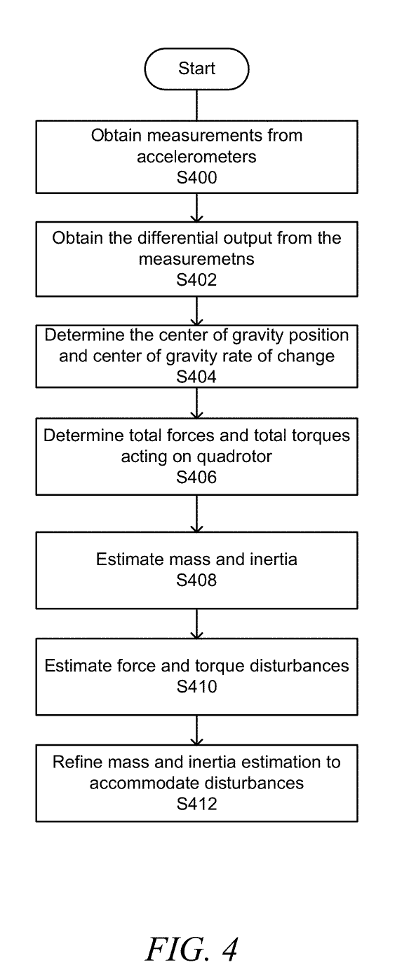

FIG. 4 is a flow chart showing a method for calculating the navigation parameters according to one example. At step S400, the accelerometers' measurements can be obtained from the installed accelerometers 101. At step S402, calculating the differential outputs of the accelerometers 101 via solving equations (5-5A) can yield several angular velocities' combinations and angular accelerations, which can be obtained linearly and algebraically. At step S404, these quantities, shown in (5A-14), can be used to estimate the center of gravity position and its rate of change using equation (15). At step S406, the total forces and total torques acting on the quadrotor can be determined via equations (16-17). At step S408, these equations can be used to facilitate estimating both the mass and inertia, as shown in equations (20), (20′), (24) and (27), assuming no force or torque disturbances. Since there can be some force or torque disturbances acting on the quadrotor during the estimation process, the disturbances are determined in step S410. At step S412, estimation models as shown in (28) and (29) were refined to accommodate the disturbances.

The system and associated methodology of the present disclosure enables improving the stability and flight of the vehicle under the simultaneous action of varying force and torque disturbances. The method calculates navigation parameters such as inertial position, velocity and acceleration, angular velocity and acceleration, estimating the position of center of gravity and its rate of change, and estimating the mass and inertia using only linear accelerometers.

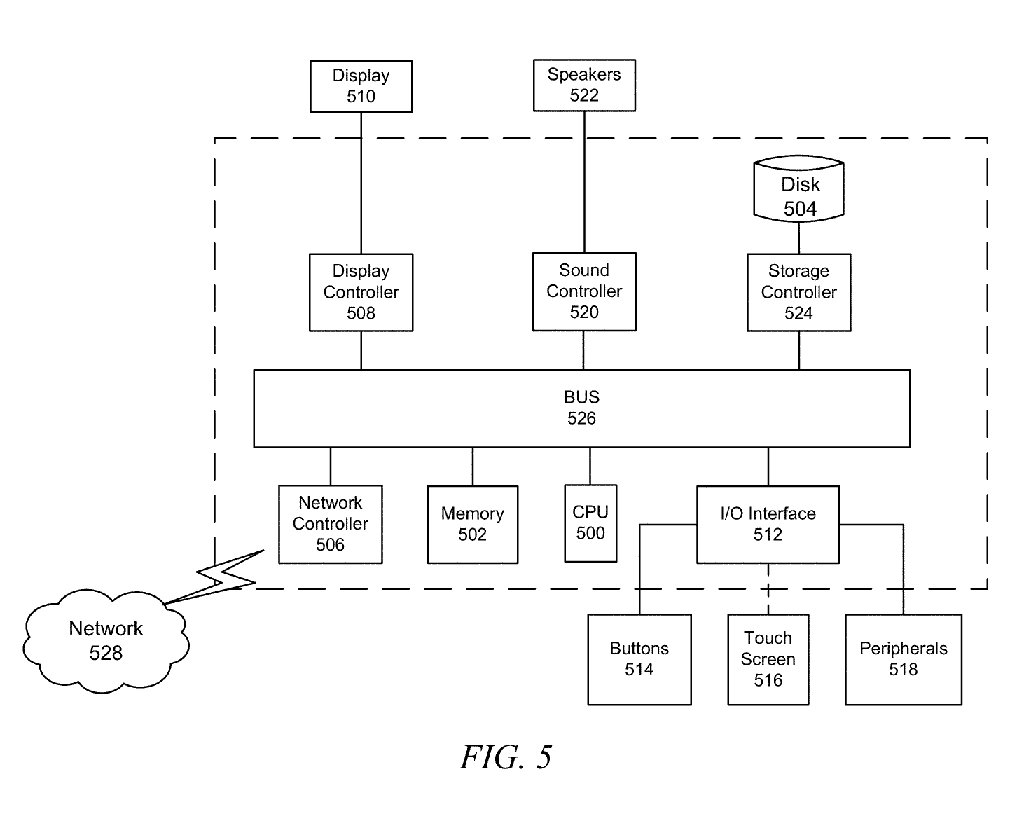

In one embodiment, measurements from the inertial measurement units (IMUs) may be sent via a network 528 to a computer. In other embodiments, the IMUs may include processing circuitry to compute the navigation parameters. The IMU may include a data processing system, as shown in FIG. 5, to create a particular machine for implementing the above-noted process.

Next, a hardware description of the computer according to exemplary embodiments is described with reference to FIG. 5. In FIG. 5, the computer includes a CPU 500 which performs the processes described above/below. The process data and instructions may be stored in memory 502. These processes and instructions may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer communicates, such as a server or computer.

Further, the claimed advancements may be provided as a utility application, background daemon, or component of an operating system, or combination thereof, executing in conjunction with CPU 500 and an operating system such as Microsoft Windows 7, UNIX, Solaris, LINUX, Apple MAC-OS and other systems known to those skilled in the art.

The hardware elements in order to achieve the computer may be realized by various circuitry elements, known to those skilled in the art. For example, CPU 500 may be a Xenon or Core processor from Intel of America or an Opteron processor from AMD of America, or may be other processor types that would be recognized by one of ordinary skill in the art. Alternatively, the CPU 500 may be implemented on an FPGA, ASIC, PLD or using discrete logic circuits, as one of ordinary skill in the art would recognize. Further, CPU 500 may be implemented as multiple processors cooperatively working in parallel to perform the instructions of the inventive processes described above.

The computer in FIG. 5 also includes a network controller 506, such as an Intel Ethernet PRO network interface card from Intel Corporation of America, for interfacing with network 528. As can be appreciated, the network 528 can be a public network, such as the Internet, or a private network such as an LAN or WAN network, or any combination thereof and can also include PSTN or ISDN sub-networks. The network 528 can also be wired, such as an Ethernet network, or can be wireless such as a cellular network including EDGE, 3G and 4G wireless cellular systems. The wireless network can also be WiFi, Bluetooth, or any other wireless form of communication that is known.

The computer further includes a display controller 508, such as a NVIDIA GeForce GTX or Quadro graphics adaptor from NVIDIA Corporation of America for interfacing with display 510, such as a Hewlett Packard HPL2445w LCD monitor. A general purpose I/O interface 512 interfaces with a keyboard and/or mouse 514 as well as a touch screen panel 516 on or separate from display 510. General purpose I/O interface also connects to a variety of peripherals 518 including printers and scanners, such as an OfficeJet or DeskJet from Hewlett Packard.

A sound controller 520 is also provided in the computer, such as Sound Blaster X-Fi Titanium from Creative, to interface with speakers/microphone 522 thereby providing sounds and/or music.

The general purpose storage controller 524 connects the storage medium disk 504 with communication bus 526, which may be an ISA, EISA, VESA, PCI, or similar, for interconnecting all of the components of the computer. A description of the general features and functionality of the display 510, keyboard and/or mouse 514, as well as the display controller 508, storage controller 524, network controller 506, sound controller 520, and general purpose I/O interface 512 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 5.

The present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The hardware description above, exemplified by any one of the structure examples shown in FIG. 5 constitutes or includes specialized corresponding structure that is programmed or configured to perform the algorithms shown in FIG. 4. For example, the algorithms shown in FIG. 4 may be completely performed by the circuitry included in the single device shown in FIG. 5.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1. A method for determining one or more navigation parameters of a vehicle, the method comprising:
detecting a plurality of angular acceleration values via a plurality of accelerometers mounted on the vehicle wherein said vehicle is in motion;
calculating a plurality of differential values based on the acceleration values;
calculating an initial inertia value of the vehicle based on the differential values;
calculating an initial mass value of the vehicle based on the differential values;
obtaining a plurality of disturbance parameters;
calculating a refined inertia value based on the initial inertia value and at least one disturbance parameter;
calculating a refined mass value based on the initial mass value and at least one disturbance parameter; and
determining navigation parameters based on the refined inertia value and the refined mass value.

2. The method of claim 1, wherein the at least one disturbance parameter is a force disturbance.

3. The method of claim 1, wherein the at least one disturbance parameters is a torque disturbance.

4. The method of claim 1, wherein the vehicle includes six tri-axial accelerometers, wherein the accelerometers are linear accelerometers and are arranged in one or more tetrahedral configurations.

5. The method of claim 1, wherein the vehicle includes five tri-axial accelerometers, wherein the accelerometers are linear accelerometers and are arranged in one or more cone configurations.

6. The method of claim 1, wherein the mass, inertia, and center of gravity coordinates can be estimated fully while the vehicle is in motion.

7. The method of claim 1, wherein the angular motion quantities needed to estimate the initial mass and initial inertia includes applying:
$${\dot{Ω}}_{x} = \frac{1}{4 μ} ( {A}_{3 z} - {A}_{4 z} - {A}_{5 y} + {A}_{6 y} )$$
$${\dot{Ω}}_{y} = \frac{1}{4 μ} ( {A}_{5 x} - {A}_{6 x} - {Z}_{1 z} + {A}_{2 z} )$$
$${\dot{Ω}}_{z} = \frac{1}{4 μ} ( {A}_{1 y} - {A}_{2 y} - {A}_{3 x} + {A}_{4 x} )$$
$${Ω}_{x} {Ω}_{y} = \frac{1}{4 μ} ( {A}_{1 y} - {A}_{2 y} + {A}_{3 x} - {A}_{4 x} )$$
$${Ω}_{x} {Ω}_{z} = \frac{1}{4 μ} ( {A}_{1 z} - {A}_{2 z} + {A}_{5 x} - {A}_{6 x} )$$
$${Ω}_{y} {Ω}_{z} = \frac{1}{4 μ} ( {A}_{3 z} - {A}_{4 z} + {A}_{5 y} - {A}_{6 y} )$$
$${Ω}_{x}^{2} = \frac{1}{4 μ} ( {A}_{1 x} - {A}_{2 x} - {A}_{3 y} + {A}_{4 y} - {A}_{5 z} + {A}_{6 z} )$$
$${Ω}_{y}^{2} = \frac{1}{4 μ} ( - {A}_{1 x} + {A}_{2 x} + {A}_{3 y} - {A}_{4 y} - {A}_{5 z} + {A}_{6 z} )$$
$${Ω}_{z}^{2} = \frac{1}{4 μ} ( - {A}_{1 x} + {A}_{2 x} - {A}_{3 y} + {A}_{4 y} + {A}_{5 z} - {A}_{6 z} )$$
where all the accelerometers are positioned symmetrically around a point m at a distance μ, where Aᵢ is a tri-axial linear accelerometer's measurement, Ω is the angular velocity, and \dot{Ω}ₓ is the angular acceleration.

8. The method of claim 1, wherein a total force quantity needed to estimate the initial mass includes applying:
$${\vec{F}}_{Total} = {\sum }_{i = 1}^{q} {\vec{F}}_{i} + {\vec{F}}_{disturbance} = {\vec{F}}_{propellers} + {\vec{F}}_{disturbance} = {m}_{Total} ( {\ddot{\vec{R}}}_{I} + {\vec{g}}_{b} )$$
where:
q is the number of propellers on the vehicle, [symbol]
is the force generated by the i^{th} motor-propeller setup,
m_{Total} is the total mass of the quadrotor and the added objects, [symbol]
stands for all uncounted for forces resulting from drag forces, propeller flapping and the like.

9. The method of claim 1, wherein a total torque quantity needed to estimate the initial inertia includes applying:
$${\vec{T}}_{Total} = {\sum }_{i = 1}^{q} ( {\vec{d}}_{i} + {\vec{F}}_{i} ) + {\vec{T}}_{disturbance} = {\vec{T}}_{propellers} + {\vec{T}}_{disturbance} = {I}_{Total} \dot{\vec{Ω}} + \vec{Ω} \times {I}_{Total} \vec{Ω}$$
where: [symbol]
is the distance between the hub of the i^{th} propeller from the center of gravity,
I_{Total} is the total inertia of the quadrotor and the added objects evaluated at the center of gravity, [symbol]
stands for all uncounted for torques resulting from drag forces, propeller flapping and the like.

10. The method of claim 1, wherein the calculation of the initial inertia at the center of gravity includes applying:
$${\vec{T}}_{Total} = {\vec{T}}_{propellers} = [ \begin{matrix}{\dot{Ω}}_{x} + {Ω}_{y} {Ω}_{z} & {\dot{Ω}}_{x} - {Ω}_{y} {Ω}_{z} & 0 \\ 0 & {\dot{Ω}}_{y} + {Ω}_{x} {Ω}_{z} & - {\dot{Ω}}_{y} + {Ω}_{x} {Ω}_{z} \\ {\dot{Ω}}_{z} - {Ω}_{x} {Ω}_{y} & 0 & - {\dot{Ω}}_{z} - {Ω}_{x} {Ω}_{y}\end{matrix} ] [ \begin{matrix}{I}_{:} \\ {I}_{:} \\ I\end{matrix} + [ \begin{matrix}{\dot{Ω}}_{y} - {Ω}_{x} {Ω}_{z} & {\dot{Ω}}_{z} + {Ω}_{x} {Ω}_{y} & {Ω}_{y}^{2} - {Ω}_{z}^{2} \\ {\dot{Ω}}_{x} + {Ω}_{y} {Ω}_{z} & {Ω}_{z}^{2} - {Ω}_{x}^{2} & {\dot{Ω}}_{z} - {Ω}_{x} {Ω}_{y} \\ {Ω}_{x}^{2} - {Ω}_{y}^{2} & {\dot{Ω}}_{x} - {Ω}_{y} {Ω}_{z} & {\dot{Ω}}_{y} + {Ω}_{x} {Ω}_{z}\end{matrix} ] [ \begin{matrix}{I}_{xy} \\ {I}_{xz} \\ {I}_{yz}\end{matrix} ] \\ where [ \begin{matrix}{I}_{xx} \\ {I}_{yy} \\ {I}_{zz}\end{matrix} ] = \frac{1}{2} [ \begin{matrix}1 & 1 & 0 \\ 0 & 1 & - 1 \\ 1 & 0 & - 1\end{matrix} ] [ \begin{matrix}{I}_{xx} - {I}_{yy} + {I}_{zz} \\ {I}_{xx} + {I}_{yy} - {I}_{zz} \\ {I}_{xx} - {I}_{yy} - {I}_{zz}\end{matrix} ]$$
where: [symbol]
is the total torque of the propellers, [symbol]
is the angular velocity, [symbol]
is the angular acceleration, and [symbol]
is the inertia component.

11. The method of claim 1, wherein the calculation of a payload inertia with respect to a total inertia at the center of gravity includes applying:
$${I}_{{Total}_{x , y , z}} = {\sum }_{i = 1}^{q} {I}_{mi , x , y , z}^{′} + {\sum }_{k = 1}^{2} {I}_{ck , x , y , z}^{′} + {I}_{payload , x , y , z} \\ {I}_{{Total}_{xy , xz , yz}} = {\sum }_{i = 1}^{q} {I}_{mi , xy , xz , yz}^{′} + {\sum }_{k = 1}^{2} {I}_{ck , xy , xz , yz}^{′} + {I}_{payload , xy , xz , yz} \qquad ( 20 )$$
where:
{i=1, 2, . . . , q} indicates the motor-propeller setup index,
k={1,2} is the cylinder index,
Iₘᵢ′ is the inertia of the i^{th} motor-propeller setup, and
I_{payload} is the inertia of the payload.

12. The method of claim 1, wherein the calculation of the initial mass includes applying:
$${m}_{Total} = \frac{{‖ {\vec{F}}_{propellers} ‖}_{2}}{{‖ {\ddot{\vec{R}}}_{I} + {\vec{g}}_{b} ‖}_{2}} , {‖ {\ddot{\vec{R}}}_{I} + {\vec{g}}_{b} ‖}_{2} \neq 0$$
where: [symbol]
is the total force of the propellers, [symbol]
is the linear inertial acceleration, and [symbol]
is the gravitational acceleration.

13. The method of claim 1, wherein the calculation of a payload mass includes applying:
$${m}_{p} = {m}_{Total} - {\sum }_{i = 1}^{q} {m}_{mi} - 2 {m}_{c}$$
where:
m_{Total} is the total mass,
mᵢₙᵢ is the mass of the i^{th} motor-propeller setup, and
2m_{c} is the mass of the quadrotor frame when approximated as two perpendicular thin rods.

14. The method of claim 9, wherein the calculation of the refined inertia at the center of gravity includes applying:
$$\dot{\vec{Ω}} = {I}_{Total}^{- 1} {\vec{T}}_{propellers} + {I}_{Total}^{- 1} {\vec{T}}_{disturbance} - {I}_{Total}^{- 1} ( \vec{Ω} \times {I}_{Total} \vec{Ω} )$$
where:
Ω is the angular velocity, [symbol]
is the angular acceleration,
I_{Total} is the total inertia of the quadrotor and the added objects evaluated at the center of gravity, [symbol]
is the total torque of the propellers, and [symbol]
stands for all uncounted for torques resulting from drag forces, propeller flapping and the like.

15. The method of claim 11, wherein the calculation of the refined mass includes applying:
$${\vec{F}}_{propellers} = [ \begin{matrix}{\ddot{R}}_{I , x} + {g}_{b , x} & - 1 & 0 & 0 \\ {\ddot{R}}_{I , y} + {g}_{b , y} & 0 & - 1 & 0 \\ {\ddot{R}}_{I , z} + {g}_{b , z} & 0 & 0 & - 1\end{matrix} ] [ \begin{matrix}{m}_{Total} \\ {F}_{disturbance , x} \\ {F}_{disturbance , y} \\ {F}_{disturbance , z}\end{matrix} ]$$
where: [symbol]
is the total force of the propellers, [symbol]
is the linear acceleration, [symbol]
is the gravitational acceleration,
m_{Total} is the total mass, and [symbol]
stands for all uncounted for forces resulting from drag forces, propeller flapping and the like.

16. The method of claim 1, further comprising controlling the vehicle based on the navigation parameters.

17. The method of claim 16, wherein controlling the vehicle based on the navigation parameters includes calculating the refined mass and inertia values and providing instruction to at least one propeller to alter an applied force on the vehicle to redirect the motion of the vehicle.

18. A system for determining navigation parameters of a vehicle, the system comprising:
processing circuitry configured to:
detect a plurality of angular acceleration values via a plurality of accelerometers mounted on the vehicle wherein said vehicle is in motion,
calculate a plurality of differential values based on the acceleration values,
calculate an initial inertia value of the vehicle based on the differential values,
calculate an initial mass value of the vehicle based on the differential values,
obtain a plurality of disturbance parameters,
calculate a refined inertia value based on the initial inertia value and a first one of the disturbance parameters,
calculate a refined mass value based on the initial mass value and a second one of the disturbance parameters, and
determine navigation parameters based on the refined inertia value and the refined mass value.

19. The system of claim 18, wherein the processing circuitry is further configured to:
control the vehicle based on the navigation parameters.

20. The system of claim 19, wherein controlling the vehicle based on the navigation parameters includes calculating the refined mass and inertia values and providing instruction to at least one propeller to alter an applied force on the vehicle to redirect the motion of the vehicle.
